(19) United States
(12) Patent Application Publication
(10) Pub. No.: US 2016/0061791 A1
(43) Pub. Date: Mar. 3, 2016

(54) Automatic Ammonium Analyzer

(71) Applicant: Endress + Hauser Conducta Gesellschaft für Mess- und Regeltechnik mbH + Co. KG, Gerlingen (DE)

(72) Inventor: Ulrich Kathe, Ludwigsburg (DE)

(21) Appl. No.: 14/835,927

(22) Filed: Aug. 26, 2015

(30) Foreign Application Priority Data
Sep. 1, 2014 (DE) 10 2014 112 560.6

(51) Int. Cl. G01N 31/00; G01J 1/42; G01N 21/77; G01N 21/59; C25B 1/26; C25B 9/06

(52) U.S. Cl. CPC G01N 31/002; C25B 1/26; C25B 9/06; G01N 21/77; G01N 21/59; G01J 1/42; G01N 2201/061

(57) ABSTRACT

For an automated determination of a ammonia nitrogen content in a liquid sample, an analyzer and method are provided. The following steps are performed by the method: generating a reagent solution by electrolysis that contains hypochlorite ions to be added to the liquid sample, and feeding the reagent solution into the liquid sample; feeding at least one other reagent solution into the liquid sample and generating a reaction mixture from the reagent solutions and the liquid sample; sensing a measuring signal with a photometric measuring device that correlates with a measuring variable of the reaction mixture; and on the basis of the measuring signal, determining a measuring value for the ammonia nitrogen content with an electronic control device.

The invention concerns an analyzer and a method for the automatic determination of the content of ammonia nitrogen in a liquid sample.

Measuring the content of ammonia nitrogen (NH₄—N) plays an important role in environmental measuring and process technology, especially in the context of cleaning and treating urban and industrial wastewater. Bodies of water contain nitrogen in elemental form as well as in inorganic and organic compounds. Organically bonded nitrogen usually is present in the form of proteins that can be degraded into inorganic nitrogen compounds by micro-organisms. Inorganic nitrogen compounds in bodies of water are, for example, nitrate, nitrite and ammonium. The ammonia nitrogen content of a body of water is an important indicator of the influences from wastewater, treatment plants, fertilizer runoff and others. This parameter allows one to express statements regarding the level of pollution and water quality.

Urban and industrial treatment plants biologically degrade ammonia nitrogen in a nitrification process. Measuring the content of ammonia nitrogen in the water supplied during the biological cleaning phase to control and/or adjust the respective degradation processes plays an important role.

For an automated determination of the ammonia nitrogen content in water samples, automatic ammonium analyzers are used which determine ammonia nitrogen photometrically using indophenol blue. This method has been described in, for example, DIN 38406. The indophenol blue process is based on the fact that ammonium (NH₄⁺—) ions in an alkaline pH range with hypochlorite and salicylate ions react to a blue color (indophenol blue color) in the presence of sodium pentacyanonitrosylferrate as a catalyst. Traditionally, hypochlorite ions (OCl—) are obtained by the hydrolysis of dichloroisocyanuric acid.

Consequently, an automatic analyzer based on the indophenol blue method mainly needs three reagent solutions, namely a salicylate solution, a sodium pentacyanonitrosylferrate solution (sodium nitroprusside solution) and an alkaline dichloroisocyanuric acid solution and/or a solution of a salt thereof, e.g. sodium dichlorisocyanurate.

Stocking and using alkaline dichlorisocyanuric acid solution in an automatic analyzer for any length of time is problematic, since dichlorisocyanuric acid or dichlorisocyanurate degrades over time. If the ambient temperatures are high, e.g. between 30 and 40° C., they may be used for the determination of the ammonia nitrogen content in an automatic analyzer for a few days only. Due to the decreasing concentration of the dichlorisocyanuric acid due to its self-degradation, the consequence of stocking the reagent solution for too long is a lower reading for the ammonia nitrogen determination at the top end of the measuring range of the analyzer, and, on the other hand, a higher reading in the lower measuring range. Furthermore, chlorine gas is formed as a result of the degradation of dichlorisocyanuric acid. Chlorine gas is problematic, not only for reasons of work safety and environmental protection since it is corrosive and toxic, but it also interferes with the photometric determination of the ammonia nitrogen content.

Previous approaches to reduce the problems caused by the self-degradation of dichlorisocyanuric acid are focused on adopting one or more of the following measures:

1. renewing the reagent when it has changed due to aging. This requires a rather high maintenance effort and increased use of material.

2. compensating the aging of the reagent by regularly adjusting the analyzer. However, such an adjustment process is required with increased frequency due to the rapidly changing concentration of dichlorisocyanuric acid at high temperatures, leading to high logistics expenditure.

3. cooling the reagent. This does indeed slow down the degrading reaction, but the analyzer requires a refrigeration unit for this purpose and corresponding higher energy consumption.

4. optimizing the reagent compound in such a way that the chlorine degassing is reduced. It is, for example, known that the degassing speed is less when the pH value of the reagent solution decreases.

All those approaches reduce the problems resulting from the use of dichlorisocyanuric acid, but they do not resolve them completely.

It is thus the object of the invention to provide a method and an automatic analyzer for determining the ammonia nitrogen content in liquid samples that overcomes the disadvantages set out above.

This object is solved by a method according to claim 1 and the analyzer according to claim 7.

The method according to the invention for an automated determination of the ammonia nitrogen content in a liquid sample includes:
generating a reagent solution by electrolysis that contains hypochlorite ions to be added to the liquid sample, and feeding the reagent solution into the liquid sample;
feeding at least one other reagent solution, especially one including a phenolic compound and/or pentacyanonitrosylferrate into the liquid sample and forming a reaction mixture formed from the reagent solutions and the liquid sample;
sensing a measuring signal with a photometric measuring device that correlates with a measuring variable of the reaction mixture; and
on the basis of the measuring signal, determining a measuring value for the ammonia nitrogen content with an electronic control device.

As the hypochlorite ions are generated by electrolysis instead of by hydrolysis of dichlorisocyanuric acid, the difficulties described initially that are related to the storage and the concentration of the dichlorisocyanuric acid solution decreasing over the duration of the storage no longer apply. The reactants required for generating hypochlorite by electrolysis are much more stable than the traditionally used dichlorisocyanuric acid, and therefore no measures have to be adopted to prevent a degradation of the reactants or to compensate a change in the concentration.

Hypochlorite may be generated by electrolysis of a salt solution, especially an alkaline one, especially a sodium chloride or potassium chloride solution.

For forming the reaction mixture, the liquid sample may be fed with a first reagent solution containing a phenol compound, especially thymol or a salicylate and a second reagent solution containing pentacyanonitrosylferrate (nitroprusside) as further reagent solutions.

The photometric measuring device may introduce a measuring radiation into the reaction mixture and receive the intensity of the measuring radiation after the reaction mixture has been passed through, and supply an electrical measuring system that depends on the intensity received.

The dosing of the liquid sample, the electrolytic generation of the reagent, especially of hypochlorite, the feeding and dosing of the reagents into the liquid sample and the control of the measuring device may be carried out with a control unit of the analyzer. Especially the control unit may comprise an electronic data processing device with a memory unit that contains a computer program serving to control those process steps which can execute the control unit. The control unit manages a feeding and dosing unit of the analyzer for the dosing and the transport of the liquid, with said unit possibly comprising one or several pumps as well as liquid lines that can be locked or released by valves.

Determining the current measuring value of the ammonia nitrogen content based on the measuring signal may also be executed via the control unit which can execute a computer program for this purpose that serves to determine a measuring value from the measuring signal received from the control unit according to a given algorithm.

Preferably, an amount of hypochlorite, e.g. a volume of the reagent solution containing hypochlorite is generated that suffices for exactly one detection reaction, i.e. the determination of the ammonia nitrogen content in exactly one liquid sample. In this variation of the method, the amount of hypochlorite required for the analysis cycle is generated for each analysis cycle that includes feeding and dosing the liquid sample, creating a reaction mixture from the liquid sample and the reagent solution as well as the sensing of a measuring signal and the determination of a measuring value on the basis of the measuring signal. The amount of hypochlorite may be set as a fixed amount. It is also possible to modify the set amount of hypochlorite, e.g. by user operation or automated by the control unit in the analyzer. The analyzer may, for example, be equipped to adjust the content of hypochlorite set based on one or several previously determined measuring values for the ammonia nitrogen concentration and thus ensure that the content of hypochlorite is sufficient to completely realize the chemical conversion of the ammonium contained in the liquid probe for the subsequent analysis cycle, assuming that the concentration of ammonia nitrogen for the next analysis cycle is roughly the same as for the previously determined measuring values.

In another embodiment of the method, a volume of the reagent solution comprising hypochlorite is generated that is sufficient for several detection reactions. It is, for example, possible to generate a sufficient amount of hypochlorite solution for a set frequency of analysis cycles, e.g. one analysis cycle per 10 minutes, for a certain period of time, e.g. one day. The volume to be generated may be fixed in the same way as described in the previous paragraph. The set volume to be generated may be modified by a manual input into the control unit. Alternatively, the control unit may be designed to adjust the set volume to be generated based on one or several measuring values for the ammonia nitrogen content sensed previously. The generated hypochlorite solution may be temporarily stored in a storage tank, from which the control unit extracts the amount required for one analysis cycle via the dosing and feeding device. In a variation of the method, the fill level of this storage tank may be monitored, and, should the fill level exceed or fall below a given value, the generation of a new lot, i.e. another given volume of the reagent solution comprising hypochlorite can be initiated.

The invention also includes an analyzer to determine the ammonia nitrogen content of a liquid sample, especially according to the method described above, including:
a device for the electrolysis to generate a reagent solution containing hypochlorite ions to be fed into the liquid sample,
at least a further liquid tank containing a reagent solution to be fed into the liquid sample, especially containing a phenol compound and/or pentacyanon itrosylferrate.
at least one feed and dosing device that serves to dose and feed the reagent solutions into the liquid sample and to generate a reaction mixture from the liquid sample and the reagent solutions;
a photometric measuring device to provide a measuring signal correlating to a measuring variable of the reaction mixture; and
a control device that is equipped to control the electrolysis device, the feed and dosing device and the photometric measuring device and to determine a measuring value for the ammonia nitrogen content based on the measuring signal provided by the measuring device.

The analyzer may comprise a first liquid tank containing a reagent solution containing a phenol compound, especially a thymol or salicylate solution, and a second liquid tank containing a pentacyanonitrosylferrate reagent solution.

The analyzer may also comprise a mixing device to thoroughly mix the reagent solutions with the liquid sample.

The measuring signal from the photometric measuring device may correlate with an absorption or extinction of a measuring radiation passingthrough the reaction mixture. In particular, the photometric measuring device may comprise a measuring cell to receive the reaction mixture, a source of radiation and a radiation receiver that are arranged in such a way that the measuring radiation sent from the light source impinges on the radiation receiver once it has passed through the reaction mixture. The radiation receiver may be designed to output the radiation intensity received as a measuring signal after transforming it into an electrical signal.

The device for electrolysis may be designed to electrolytically generate the reagent solution containing hypochlorite ions from an alkaline salt solution, especially from an alkaline NaCl solution.

For example, the electrolysis device may include an anode and a cathode that may be connected at least temporarily to apply a DC voltage between the anode and the cathode with a constant current source or a DC current source.

In one advantageous embodiment, the cathode may be designed as an oxygen-consuming electrode. A cathode of this type has been, for example, described in EP 115845 A2. The use of an oxygen-consuming electrode as the cathode reduces the required cell tension with respect to the electrolysis cells that deposit hydrogen at the cathode. It is furthermore advantageous that there is no hydrogen deposited in the cathode area, which increases the operational safety of the analyzer.

The electrolysis device may include an electrolysis cell with a feed and a discharge, with the internal structure of the electrolysis cell designed to receive an electrolyte, e.g. the alkaline salt solution mentioned above (including KCl and/or NaCl) being in contact with at least one surface of the anode and the cathode.

The supply and dosing device of the analyzer may be designed to supply liquid removed from the electrolysis cell to the liquid sample.

In one embodiment, the electrolysis cell may be designed as a flow cell. In this embodiment, the electrolysis may be executed in the flow of the electrolytes through the electrolysis cell.

The electrolysis cell may have a hydrogen separation chamber above the space in the electrolysis cell filled with liquid during operation, with the former being linked to a valve device of the analyzer via a gas line, in order to allow the discharge of hydrogen amassing in the hydrogen separation chamber via a gas discharge line, especially one different from the gas feed line.

The electrolysis cell may have an anode chamber that is in contact with the anode and a cathode chamber in contact with the cathode, with the anode chamber being separated from the cathode chamber via a diaphragm.

The electrolysis device may be linked via its feed line with a liquid tank that contains a preferably alkaline salt solution, especially a salt solution containing sodium chloride and/or potassium chloride.

The electrolysis device is preferably designed as a module that can be separated from the other components of the analyzer device. This allows for an easy modification of existing analyzers that work with the traditional method to determine the ammonia nitrogen concentration by using dichlorisocyanuric acid as the reagent solution.

Alternatively, the electrolysis device may also be an integral part of the measuring cell of the analyzer, in which the reaction mixture is generated and the photometric measuring variable is determined by the measuring device.

The invention is explained in further detail in the following on the basis of the embodiments shown in the illustrations. They show:

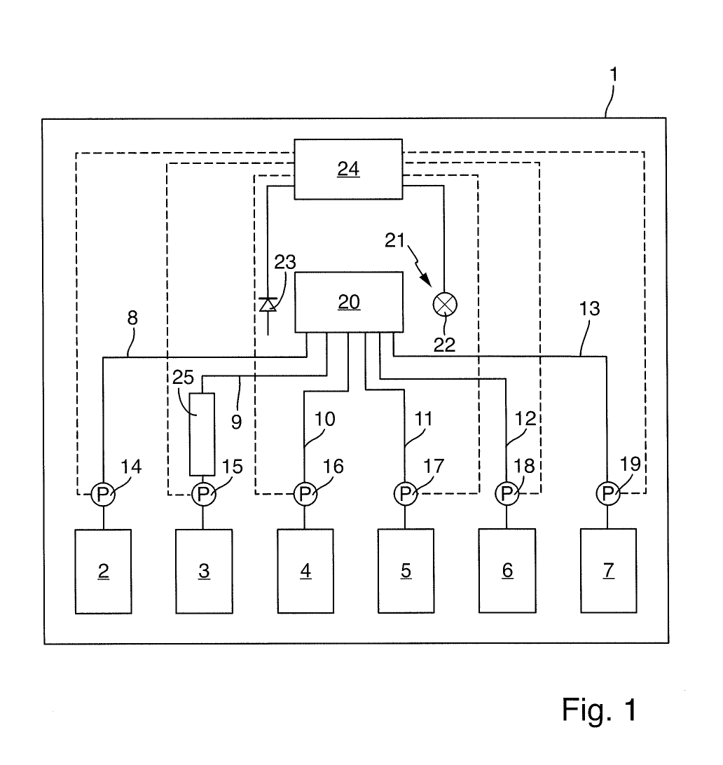

FIG. 1 a schematic overview of an analyzer to determine the ammonia nitrogen content in a liquid sample;

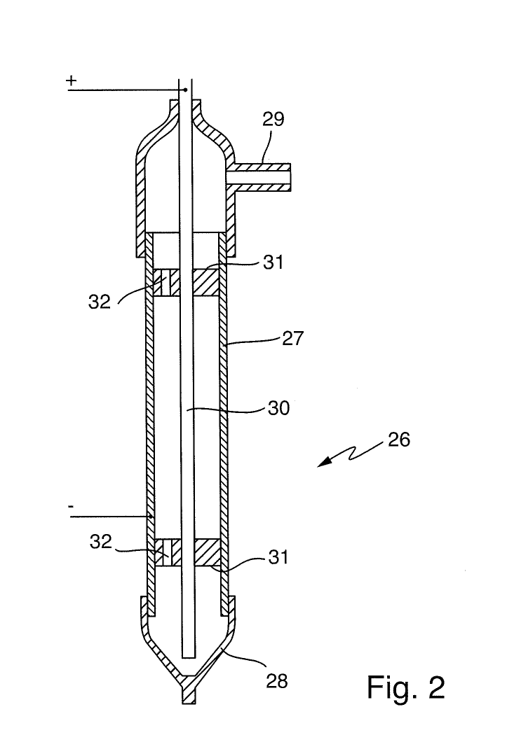

FIG. 2 a schematic overview of an electrolysis cell that can be operated in the flow to generate a reagent solution containing hypochlorite ions.

FIG. 1 shows a schematic overview of the analyzer 1 to determine the ammonia nitrogen content of a liquid sample available in a sample 2 which comprises several liquid tanks 3, 4, 5, 6 and 7, a dosing and feed device with a multitude of liquid lines 8, 9, 10, 11, 12 and 13, a multitude of pumps 14, 15, 16, 17, 18 and 19, e.g. membrane pumps, plunger pumps, especially syringe pumps, or hose pumps and a multitude of valves (not shown) to transport liquids from the liquid tanks 3, 4, 5, 6 or the sample provider 2 into the measuring cell 20 and/or discharge used liquids from the measuring cell 20 into the liquid tank 7 serving as a waste container. Instead of a multitude of valves and a multitude of pumps, the analyzer 1 in an alternative embodiment may comprise a central valve system and/or one or few pumps to transport liquid from the liquid tanks 3, 4, 5 and 6 into the measuring cell 20. The analyzer 1 furthermore comprises an optical measuring receiver 21 that comprises a radiation source 22 emitting the measuring radiation and a receiver 23 that are arranged in such a way to the measuring cell 20 that is transparent for the measuring radiation that the measuring radiation runs through a liquid reaction mixture contained in the measuring cell 20 and impinges on the receiver 23 after passing through the reaction mixture and the walls or windows of the measuring cell 20.

The analyzer 1 further comprises a sample provider 2 where the liquid to be analyzed is temporarily stored after being taken from a tapping point, e.g. an open body of water or a process tank. A liquid sample of a set volume is retrieved from the sample provider 2 to execute the analysis and transported into the measuring cell 20 via the feed line 8. The pump 14 may be designed as a membrane pump, plunger pump, especially a syringe pump, or as a hose pump like the other pumps 15, 16, 17, 18 and 19. However, such a sample provider is not obligatory. The analyzer may alternatively be designed to directly aspirate the liquid sample from the sample tapping point. In this case, the liquid feed line 8 leads directly to the sample tapping point.

The analyzer 1 can be run in full automatic mode. For this purpose, it is equipped with a control unit 24 that in the example shown here also fulfills the function of an evaluation device, especially the determination of the ammonia nitrogen content based on a measuring value sensed with the measuring sensor 21. The control unit 24 comprises a data processing unit with a memory that provides one or several operating programs the data processing unit can execute and that serve to control the analyzer 1 to conduct analyses and, if required, the evaluation of the measuring signal delivered by the optical measuring sensor 22. A data processing apparatus may also have an input device to allow an operator to enter commands or parameters and/or an interface to receive commands, parameters or other data from a superior unit, e.g. a process control system linked to the control unit 24. In addition, the control unit 24 may also have an output device to output data, especially measuring devices or operating information to a user and for the output of data to the superior unit via an interface. The control unit 24 is connected to the drives of the pumps 14, 15, 16, 17, 18 and 19 and with the valves mentioned above that are not shown in the figure in detail, to automatically operate those to transport the liquids from the sample provider 2 and the liquid tanks 3, 4, 5 and 6, into the measuring cell 20. The control unit 24 is furthermore linked to the measuring sensor 21 to control it and determine the measuring variable to be detected from the measuring signals of the receiver 23.

The analyzer 1 is designed to determine the ammonia nitrogen content in a liquid sample taken from the sample provider 2 according to the indophenol blue method.

As described at the beginning, this method consists of blending and mixing the sample with a first reagent solution containing hypochlorite ions, a second reagent solution containing salicylate and a third reagent solution containing sodium pentacyanonitrosylferrate. For this purpose, the analyzer may have a mixing device that may, for example be realized as an agitator integrated into the measuring cell 20. Ammonium NH₄⁺ is present in the alkaline reaction mixture obtained in this way as ammoniac NH₃. Together with hypochlorite chloramine, ammoniac forms NH₂Cl. This in turn reacts with salicylate, catalyzed by sodium pentacyanonitrosylferrate to N-chloride quinoneimine and to the indophenol blue color when further salicylate is added, see DIN 38406-E05.

In this present example, the liquid tank 4 contains a salicylate solution and the liquid tank 5 a reagent solution containing sodium pentacyanonitrosylferrate. The liquid tank 7 serves as a waste container for used liquids. The liquid container 6 may include a cleaning solution that may be flushed occasionally through the measuring cell 20 and the liquid lines between the analysis cycles to clean them. Alternatively, the liquid container 6 may contain a standard solution that serves to calibrate and/or adjust the analyzer 1. Naturally, other liquid tanks connected to the measuring cell 20 with other standard solutions, e.g. different ammonia concentrations may be added.

The analyzer 1 is designed to generate the first reagent solution containing hypochlorite by electrolysis of an alkaline sodium chloride solution. The sodium chloride solution is contained in the liquid tank 3. The analyzer 1 contains an electrolysis device 25 that is connected with the liquid tank 3 and the measuring cell 20 via the liquid line 9. The pump 15 serves to transport liquid from tank 3 to the measuring cell through the electrolysis device 25. While passing through the electrolysis device 25, the sodium chloride solution flows through an electrolysis cell that generates hypochlorite ions so that the liquid leaving the electrolysis device 25 in the direction of the measuring cell 20 contains hypochlorite and may be mixed into the liquid sample as a reagent solution containing hypochlorite. Preferably, the alkaline sodium chloride solution contains hycrooxyle ions in such an amount that a pH value of more than 12 is obtained when the reagent solution made with the sodium chloride solution is mixed with the liquid sample. Alternatively, the reaction mixture may be made alkaline by adding a solution containing hydroxide ions, e.g. NaOH solution.

FIG. 2 shows an electrolysis cell 26 that may be used in the electrolysis device 25 of the analyzer 1 shown in FIG. 1. The electrolysis cell 26 comprises a casing pipe 27 in the present example, at the ends of which there is a connection element that forms a supply 28 and a discharge 29. The walls of the casing pipe 27 may, as in the example shown here, serve as an electrode itself, in this case as a cathode and in this case consists of a cathode material such as stainless steel, titanium, platinum or is designed as an oxygen-consuming electrode. The cathode may, in an alternative embodiment, also be designed in the wall of the casing of an insulating cylindrical casing of the electrolysis cell or designed as a coating of the inner casing wall.

The anode 30 in the present example runs along the pipe axis of the casing pipe 27. It is designed in the shape of a rod and may comprise graphite, platinum, boron-doped diamond or a platinum iridium alloy as the electrode material. The anode 30 is centered with regard to the casing pipe 27 with two distance holders 31 that have clearance holes running parallel to the pipe axis of the casing pipe 27 to allow the electrolyte to flow through the electrolysis cell 26.

The anode 30 and the cathode 27 are connected with an electrolysis circuit (not shown) that is also part of the electrolysis device 25. The electrolysis circuit comprises a constant current source connectible to the cathode 27 and the anode 30 and is designed to apply a given voltage between anode 30 and cathode 27 in such a way that in case the cathode 27 is designed as a traditional metal electrode, e.g. of stainless steel or titanium, the electrode reactions follow these equations:

Anode: 2Cl⁻→Cl2+2e⁻

Cathode: 2H₂O+2e⁻→2OH⁻+H₂

The Cl₂ generated at the anode continues its reaction in the alkaline with hydroxide ions to become hypochlorite according to:

2OH⁻+Cl₂→Cl⁻+ClO⁻+H₂O

If the input 28 receives an alkaline NaCl solution as the electrolyte in the electrolysis cell 26 and a voltage that is sufficient for the completion of the electrode reaction is applied between anode 30 and cathode 27, the electrolyte leaving the electrolysis cell 26 via the outlet 29 contains hypochlorite in a amount that depends on the voltage exchanged between anode 30 and cathode 27 in the electrolysis cell 26 and may be added to the liquid sample to be analyzed in the analyzer 1 as a reagent containing hypochlorite to prove the content of ammonia nitrogen in the liquid sample.

As mentioned above, the cathode may be designed as an oxygen-consuming electrode. Oxygen-consuming electrodes have finely distributed, metallic silver as a catalyst for the oxygen reduction. The cathode reaction in this case follows the equation:

Cathode: 2H₂O+O₂+4e⁻→4OH⁻

In one possible embodiment of the method, the oxygen-consuming electrode is supplied with oxygen to ensure a complete conversion according to the reaction equation above.

In another alternative embodiment, the electrolysis cell may be designed as a batch reactor that shows a casing that is divided into an anode chamber and a cathode chamber by a membrane. In the anode chamber, an anode is arranged made of one of the materials mentioned above while the cathode chamber contains a cathode made of one of the above-mentioned cathode materials. In this case, a given amount of electrolyte solution, e.g. an alkaline sodium chloride solution is fed into the anode chamber; water may be fed into the cathode chamber. In this case, the electrolysis does not generally occur in through-flow. Accordingly, this embodiment is suitable, if a larger supply of reagent solution containing hypochlorite is supposed to be generated that is sufficient for the execution of several analysis cycles.

In another variation, the electrolysis device may also be integrated into the measuring cell 20.

In the area above the output 29, the hydrogen gas generated during the electrolysis (cathode reaction) may accumulate. It is advantageous to arrange a gas inlet and a gas outlet in this area of the connection piece that serves to pass an inert carrier gas or air to discharge the cathodic hydrogen that emerges. It is advantageous to use a device ventilation for the analyzer 1 for this purpose.

The electrolysis circuit of the electrolysis device 25 can be connected to the control unit 24 for the control unit 24 to control the operation of the electrolysis device.

To generate the volume of reagent solution containing hypochlorite needed for one analysis cycle of about 50 to 100 μl by electrolysis, a generator amperage of 10 mA for a duration of 50 to 100 s using an electrolyte solution with 30 g/l NaCl and 50 g/l NaOH is sufficient. The hydrogen amount released in case the cathode used is not an oxygen consuming electrode is 100 to 200 μl. This small amount causes no problems with regard to the operating safety of the electrolysis cell and the analyzer. When an oxygen-consuming electrode is used, the amount of hydrogen generated may be further reduced or even be avoided altogether.

In the following, a method to operate the analyzer is described. In order to determine the concentration of ammonia nitrogen in a liquid probe, the control unit 24 controls the pump 14 to extract a liquid sample with a set volume from sample provider 2. The liquid sample is fed into the measuring cell 20. At the same time, or subsequently, an alkaline sodium chloride solution is taken from liquid tank 3 by operating the pump 15 via the control unit 24, which is then transported through the electrolysis cell 25 in which, as described above, hypochlorite ions are generated and the reagent solution emerging from the electrolysis cell 25 containing hypochlorite ions is transported via the liquid line 9, as well as another reagent solution, a set amount of which is taken from liquid tank 4 via the pump 16 flowing through the liquid line 10, and a set amount of a reagent solution containing sodium pentacyanonitrosylferrate is taken from liquid tank 5 via the pump 17 and through the liquid line 11 into the measuring cell 20. The reagent solutions create a reaction mixture in the liquid sample in the measuring cell 20; for said reaction mixture the indophenol blue color reaction described above occurs. After a given reaction time of a few minutes' duration, the control unit 24 activates the optical measuring receiver 21 to capture a measuring value that correlates with the absorption of the reaction mixture found in measuring cell 20. The measuring signal generated by the optical measuring receiver that represents an absorption or extinction of the measuring radiation when passing through the reaction mixture contained in the measuring cell is output to control unit 24 which in turn outputs a current value for the ammonia nitrogen concentration in the liquid sample based on the measuring signal or passes, via a user interface, e.g. a display and/or an interface to a superior unit, e.g. a process control device. The steps of feeding and dosing the sample, generating a reaction mixture from the liquid sample and the reagents, conducting a color reaction and capturing an absorption measuring value are referred to as analysis cycle. Once the analysis cycle is completed, the used reaction mixture is fed into the waste tank 7 from the measuring cell 20 via the liquid line 13, managed by control unit 24.

In one advantageous variation of the method, a reagent solution for the subsequent analysis cycle is already prepared in the electrolysis unit 25 while the analysis cycle is still proceeding.

Between two analysis cycles, a standard solution with known ammonia nitrogen content may be transported from liquid tank 6 using the pump 19 controlled by the control unit 24 to arrive in the measuring cell 20, and an analysis cycle is run with this solution instead of a liquid sample taken from the sample provider 2. The measuring value obtained in this way may be used to calibrate and/or adjust the analyzer 1.

The control unit 24 may optionally adapt the hypochlorite amount to be generated in the electrolysis unit based on one or more recent values determined for the ammonia nitrogen content, e.g. by maintaining the volume of the reagent solution fed at the same level, but increasing the amperage for the electrolysis or its duration to increase the concentration of hypochlorite thus generated according to Faraday's first law. In this way, the sensitivity of the color reaction may be increased.

1-19. (canceled)

20. A method for an automated determination of the ammonia nitrogen content in a liquid sample, comprising the steps of:
generating a reagent solution by electrolysis that contains hypochlorite ions to be added to the liquid sample, and feeding the reagent solution into the liquid sample;
feeding at least one other reagent solution into the liquid sample and forming a reaction mixture from the reagent solutions and the liquid sample;
sensing a measuring signal of a photometric measuring device that correlates with a measuring variable of the reaction mixture; and
determining a measuring value for the ammonia nitrogen content with an electronic control device, on the basis of the measuring signal.

21. The method according to claim 20, wherein:
the reagent solution containing hypochlorite ions is generated by electrolysis of a salt solution, said salt solution being one of:
an alkaline, and a sodium chloride or potassium chloride solution.

22. The method according to claim 20, wherein:
a solution comprising a phenol compound, which is one of: a thymol or salicylate solution, and a pentacyanonitrosylferrate solution (nitroprusside) which is fed to the liquid sample as further reagent solutions for forming the reaction mixture.

23. The method according to claim 20, wherein:
the photometric measuring device introduces a measuring radiation into the reaction mixture and receives the intensity of the measuring radiation after passing through the reaction mixture, and provides an electrical measuring system that depends on the intensity received.

24. The method according to claim 20, wherein:
a hypochlorite amount is produced that is sufficient for exactly one detection reaction.

25. The method according to claim 20, wherein:
a hypochlorite amount is produced that is sufficient for several detection reactions.

26. An analyzer for determining an ammonia nitrogen content in a liquid sample, comprising:
an electrolysis device for generating a reagent solution containing hypochlorite ions to be fed into the liquid sample;
at least one liquid tank containing a reagent solution to be fed into the liquid sample, which contains one of: a phenol compound and/or pentacyanonitrosylferrate;
at least one feed and dosing device that serves to dose and feed the reagent solutions into the liquid sample to form a reaction mixture from the liquid sample and the reagent solutions;
a photometric measuring device to provide a measuring signal correlated to a measuring variable of the reaction mixture; and
a control device that is equipped to control said electrolysis device, said feed and dosing device and said photometric measuring device, and to determine a measuring value for the ammonia nitrogen content based on the measuring signal provided by said measuring device.

27. The analyzer according to claim 26, further comprising:
a first liquid tank containing a reagent solution comprising a phenol compound, which contains one of: a thymol or salicylate solution; and
a second liquid tank containing a pentacyanonitrosylferrate reagent solution.

28. The analyzer according to claim 26, wherein:
the measuring signal from said photometric measuring device correlates with an absorption or extinction of a measuring radiation passing through the reaction mixture.

29. The analyzer according to claim 26, wherein:
said electrolysis device is designed to electrolytically generate the reagent solution containing hypochlorite ions from an alkaline salt solution, which may be from an alkaline NaCl solution.

30. The analyzer according to claim 26, wherein:
said electrolysis device includes an anode and a cathode that may be connected at least temporarily to apply a DC voltage between the anode and the cathode with a constant current source.

31. The analyzer according to claim 30, wherein:
the cathode is designed as an oxygen-consuming electrode.

32. The analyzer according to claim 30, wherein:
said electrolysis device contains an electrolysis cell with a feed line and a discharge line;
the internal part of said electrolysis cell is in contact with at least one surface of the anode and the cathode.

33. The analyzer according to claim 32, wherein:
said at least one feed and dosing device of the analyzer is designed to supply liquid removed from said electrolysis cell to the liquid sample.

34. The analyzer according to claim 32, wherein:
said cathode is designed as a flow cell.

35. The analyzer according to claim 32, wherein:
said electrolysis cell has a hydrogen separation chamber arranged above the space in said electrolysis cell filled with liquid during operation, with the former being linked to a valve device of the analyzer via a gas line, in order to allow the discharge of hydrogen amassing in the hydrogen separation chamber via a gas discharge line, which may be different from the gas feed line.

36. The analyzer according to claim 32, wherein:
said electrolysis cell has an anode chamber in contact with the anode and a cathode chamber in contact with the cathode; and
said anode chamber is separated from said cathode chamber via a diaphragm.

37. An analyzer according to claim 26, wherein:
said electrolysis device is linked via a feed line with a liquid tank that contains a preferably alkaline salt solution, which may be: a salt solution containing sodium chloride and/or potassium chloride.

38. An analyzer according to claim 26, wherein:
said electrolysis device is preferably designed as a module that can be separated from the other components of the analyzer device.
